(19) United States
(12) Patent Application Publication
(10) Pub. No.: US 2005/0057671 A1
(43) Pub. Date: Mar. 17, 2005

(54) Method to filter EM radiation of certain energies using poly silicon

(76) Inventors: Bryan G. Cole, Meridian, ID (US); Troy Sorensen, Boise, ID (US)

Correspondence Address: DICKSTEIN SHAPIRO MORIN & OSHINSKY LLP, 2101 L Street, NW, Washington, DC, 20037, US

(21) Appl. No.: 10/663,675

(22) Filed: Sep. 17, 2003

(51) Int. Cl. H04N 3/14; H04N 5/335; H04N 9/04; H04N 9/083; H04N 5/225

(52) U.S. Cl. 348/273; 348/342

(57) ABSTRACT

Filter arrays for allowing light from desired energies to enter specific pixels are disclosed. Polysilicon or epitaxial crystal silicon layers of tailored thicknesses can be patterned to cover red and green pixel photosensors. Additional polysilicon or epitaxial crystal silicon layers can be patterned over the already-formed polysilicon or epitaxial crystal silicon layers to cover only red pixel photosensors.

### FIELD OF THE INVENTION

The present invention relates to filtering electromagnetic (EM) radiation in a semiconductor imager.

### BACKGROUND OF THE INVENTION

There are a number of different types of semiconductor-based imagers, including charge coupled devices (CCDs), photo diode arrays, charge injection devices and hybrid focal plane arrays. CCDs are often employed for image acquisition for small size imaging applications. CCDs are also capable of large formats with small pixel size and they employ low noise charge domain processing techniques. However, CCD imagers have a number of disadvantages. For example, they are susceptible to radiation damage, they exhibit destructive read out over time, they require good light shielding to avoid image smear and they have a high power dissipation for large arrays.

Because of the inherent limitations in CCD technology, there is an interest in complementary metal oxide semiconductor (CMOS) imagers for possible use as low cost imaging devices. A fully compatible CMOS sensor technology enabling a higher level of integration of an image array with associated processing circuits would be beneficial to many digital applications such as, for example, in cameras, scanners, machine vision systems, vehicle navigation systems, video telephones, computer input devices, surveillance systems, auto focus systems, star trackers, motion detection systems, image stabilization systems and data compression systems for high-definition television.

A CMOS imager circuit includes a focal plane array of pixel cells, each one of the cells including a photosensitive element. For example, the photosensitive element could be a photo diode, a photogate or a photoconductor overlying a doped region of a substrate for accumulating photo-generated charge in the underlying portion of the substrate. The photosensitive element of a CMOS imager pixel typically includes either a depleted p-n junction photo diode or a field induced depletion region beneath a photogate.

To perform color imaging, an imager's pixel array must include pixels that sense radiation of different colors. One conventional technique is to filter incoming light so that light of different colors reaches different pixels. Many CCD and CMOS imager chips use a colored filter array (CFA), located above metal layers in the pixel array, with each pixel's filter passing predominantly red, green or blue photons.

FIG. 1 depicts a pixel mosaic Bayer color filter array (CFA) pattern commonly utilized in digital cameras, wherein green pixels are configured in a checkerboard-type pattern and an alternating arrangement of red and blue pixels fill in the remainder of the pattern. In order to fabricate the filter of FIG. 1, four mask layers are typically required, one each for a blue, red, and green filter, and one for a clear coat filter.

It would be advantageous to have filtering techniques that can be implemented more efficiently than conventional color filters, that require fewer mask layers, and that reduce contamination from Na, Cu and other elements in CFA materials.

### SUMMARY OF THE INVENTION

Embodiments of the present invention provide imagers and associated fabrication techniques in which polysilicon or epitaxial crystal silicon is used to filter colors propagated to photo conversion elements. The invention can be applied in CMOS and CCD imaging devices, image pixel arrays in CMOS and CCD imaging devices, and CMOS and CCD imager systems. The invention requires fewer mask layers as compared to conventional color filters, and reduces contamination from Na, Cu and other elements in CFA materials.

These and other features and advantages of the invention will be more apparent from the following detailed description that is provided in connection with the accompanying drawings and illustrated exemplary embodiments of the invention.

### BRIEF DESCRIPTION OF THE DRAWINGS

FIG. 1 depicts a pixel mosaic Bayer color filter array (CFA) pattern commonly utilized in digital cameras.

FIG. 2 illustrates a filtering technique based on the percentages of red, green and blue incident light that travel to a certain depth due to the absorption coefficient of undoped polysilicon.

FIG. 3 depicts a schematic cross-sectional view of a blue pixel for use in a CMOS or CCD image device in accordance with a first embodiment of the present invention.

FIG. 4 depicts a schematic cross-sectional view of a green pixel for use in a CMOS or CCD image device in accordance with the first embodiment of the present invention.

FIG. 5 depicts a schematic cross-sectional view of a red pixel for use in a CMOS or CCD image device in accordance with the first embodiment of the present invention.

FIG. 6 is a graph showing the percentage of light transmitted as a function of wavelength of incident light for the pixels in FIGS. 4 and 5.

FIG. 7 depicts a schematic cross-sectional view of a blue pixel for use in a CMOS or CCD image device in accordance with a second embodiment of the present invention.

FIG. 8 depicts a schematic cross-sectional view of a green pixel for use in a CMOS or CCD image device in accordance with the second embodiment of the present invention.

FIG. 9 depicts a schematic cross-sectional view of a red pixel for use in a CMOS or CCD image device in accordance with the second embodiment of the present invention.

FIG. 10 is a graph showing the percentage of light transmitted as a function of wavelength of incident light for the pixels in FIGS. 8 and 9.

FIG. 11 illustrates a block diagram of a CMOS imager integrated circuit (IC) having a pixel array according to an exemplary embodiment of the present invention.

FIG. 12 illustrates a schematic diagram of a computer processor system that may include a CMOS imager IC as in FIG. 11.

### DETAILED DESCRIPTION OF THE INVENTION

In the following detailed description, reference is made to various specific embodiments in which the invention may be practiced. These embodiments are described with sufficient detail to enable those skilled in the art to practice the invention, and it is to be understood that other embodiments may be employed, and that structural and logical changes may be made without departing from the spirit or scope of the present invention.

The terms “substrate” and “wafer” can be used interchangeably in the following description, and may include any structure in or at a surface of which circuitry can be formed. The structure can include any of silicon, silicon-on insulator (SOI), silicon-on-sapphire (SOS), doped and undoped semiconductors, epitaxial layers of silicon supported by a base semiconductor foundation, and other semiconductor structures. The semiconductor need not be silicon-based. The semiconductor could be silicon-germanium, germanium, or gallium arsenide. When reference is made to the substrate in the following description, previous process steps may have been utilized to form layers, regions or junctions in or over the base semiconductor or foundation.

The term “pixel” refers to a discrete picture element unit cell that includes components for converting electromagnetic radiation to an electrical signal. For purposes of illustration, a representative blue pixel, green pixel and red pixel according to one embodiment of the present invention are each illustrated in the figures and description herein. In one embodiment, an array or combination can include, but is not limited to, at least one each of a blue pixel, green pixel and red pixel together to form a photoconductor array for use in a CMOS or CCD imager device.

The term “light” includes all frequencies, or wavelengths, of electromagnetic (EM) radiation, unless otherwise specifically limited. As used herein, the term “majority of light” at a wavelength means more than half the total energy of EM radiation at the wavelength.

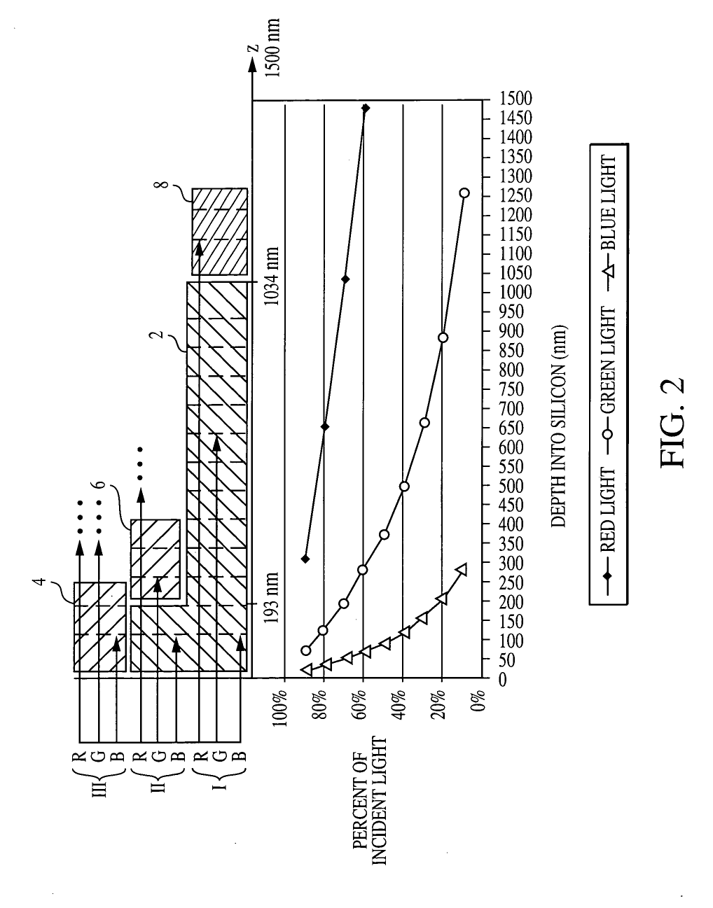

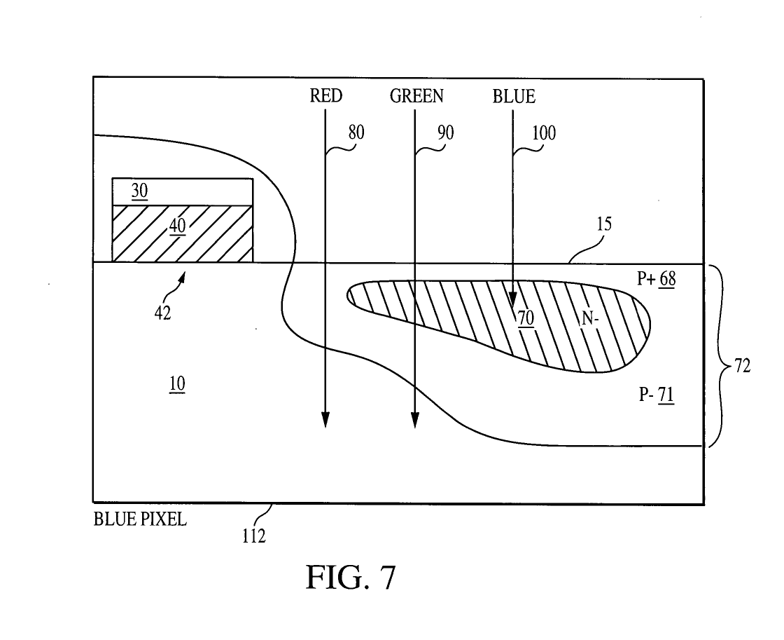

Referring now to the drawings, where like elements are designated by like reference numerals, FIGS. 2-10 illustrate exemplary embodiments of the present invention for fabricating CMOS and CCD imaging devices. FIGS. 2-6 relate to pixel cells employing polysilicon layers of optimized thicknesses that act as filters for different wavelengths of light. FIGS. 7-10 illustrate pixel cells employing epitaxial crystal silicon layers, which have also thickness and which also act as filters for different wavelengths of light.

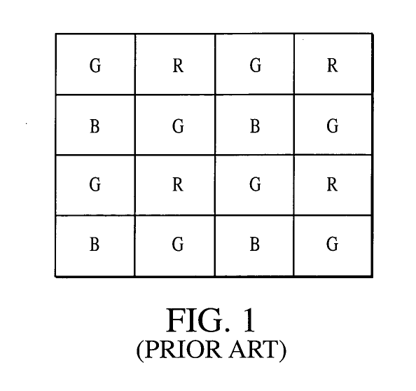

FIG. 2 illustrates a filtering technique from which the exemplary embodiments of the invention can be understood. Although, for simplicity, FIG. 1 is described below with reference to undoped polysilicon layers, it must be understood that the invention has equal applicability to embodiments where epitaxial crystal silicon is used in lieu of the undoped polysilicon. Doped polysilicon or epitaxial crystal silicon can be used as well, such as with doping concentrations of 10¹⁰-10²⁰ per cm³.

As shown in FIG. 2, polysilicon substrate 2 and sensors 4, 6, and 8 receive light of blue, green and red wavelengths (as shown, from the left). It is known that the energy bandgap (E_{G}) of silicon is 1.11 eV at 300 k, or a wavelength (λ_{G}) of 1117.8 nm. Photons with energy E≧E_{G} will be absorbed by the electrons or nucleus in the silicon lattice. Statistically, of the visible wavelengths, red light (λ=600-750 nm), will penetrate the deepest into silicon before becoming absorbed. Green light (λ=500 to 600 nm) will penetrate less, while blue light (λ=350 to 500 nm) will be quickly absorbed.

Absorption is defined as the relative decrease of the irradiance φ per unit path length, ∂φ(x)/φ=α∂x. A solution to this equation is
φ(x)=φₒe^{-αx}
where φₒ is the incident irradiance, α is the absorption coefficient and x is path length. Transmission is the amount of light at a particular wavelength (λ) that is not absorbed, and is given by the equation
T=Tₒe^{-4πkx/λ}
where T is transmission at a distance x, k is an extinction coefficient, and Tₒ is the amount of light incident on the material.

The absorption coefficient (alpha) of undoped polysilicon for several wavelengths in the visible range, as determined experimentally by Lubberts et al (see G. Lubberts, B. C. Burkley, F. Moser, and E. A. Trabka, “Optical Properties of Phosphorus-doped Polycrystalline Silicon Layers,” J. Appl. Phys. 52, 6870-6878; November 1981), is included in Table 1.

TABLE 1
Absorption coefficient in undoped
polysilicon listed by wavelength.

| Wavelength | alpha undoped |
|---|---|
| (um) | (×10E4 cm−1) |
| 0.40 | 22.7 |
| 0.45 | 8.33 |
| 0.50 | 3.7 |
| 0.55 | 1.84 |
| 0.60 | 0.981 |
| 0.65 | 0.562 |
| 0.70 | 0.345 |
| 0.75 | 0.225 |

Based on the values of alpha in Table 1, the percentage of red, green and blue light that would travel through a given thickness of polysilicon can be calculated. The graph in FIG. 2 illustrates the percentages of red, green and blue incident light that travels to a certain depth, from an entering surface, into polysilicon based on the absorption coefficient in undoped polysilicon. The closed (dark) diamonds in FIG. 2 represent the percentage of incident red light that remains at a given depth; the open circles represent the percentage of incident green light that remains at a given depth; and the open triangles represent the percentage of incident blue light that remains at a given depth. With polysilicon, increasing dopant concentration significantly decreases a for green and blue light, and will slightly increase α for λ>700 nm. With crystal silicon, increasing dopant concentration significantly increases absorption in crystal silicon.

In FIG. 2, polysilicon structure 2 has thicknesses ranging from about 1034 nm in region I, to about 193 nm in region II, to zero in region III, all as measured along the z axis. In region III, photosensor 4 receives unfiltered light, absorbs primarily blue light, and allows most green and red light to pass. In region II, photosensor 6 receives light filtered by 193 nm of polysilicon, so that about 80% of blue light has been absorbed while about 70% of green light remains; photosensor 6 absorbs primarily green light and allows most red light to pass. Similarly, in region I, photosensor 8 receives light filtered by 1034 nm of polysilicon, so that about 99% of blue light and about 85% of green light has been absorbed, while about 70% of red light remains; region 8 therefore absorbs primarily red light. Structure 2 thus acts as a filter for different colors, determining which colors will reach photosensors 6 and 8.

As noted above, although FIG. 2 has been described with reference to undoped polysilicon, epitaxial silicon may be utilized in lieu of the undoped polysilicon to filter unwanted photon energies from reaching the photodiode 72. Accordingly, referring to regions I, II and III of FIG. 2, layers of epitaxial crystal silicon employed to form blue, green and red pixels may have thicknesses ranging from about 1.5 microns (μm) in region I, to about 300 nm in region 11, to zero in region III, all as measured along the z axis. In region III, photosensor 4 receives unfiltered light, absorbs primarily blue light, and allows most green and red light to pass.

In region II, photosensor 6 may receive light filtered by about 300 nm of epitaxial crystal silicon, so that about 71% of blue light has been absorbed (i.e. only about 29% of blue light passes) while about 74% of green light remains. Thus, one embodiment may comprise a layer of epitaxial crystal silicon having a thickness of about 0.3 microns to form the green pixel. Photosensor 6 will thus absorb primarily green light and allows most red light to pass.

Two layers of epitaxial crystal silicon may be used to form a red pixel. Thus, on one exemplary embodiment, the red filter may comprise a layer of epitaxial crystal silicon having a thickness of about 1.5 microns. Referring to the above description of FIG. 2, and using a thickness of about 1.5 microns of epitaxial crystal silicon, photosensor 8 receives light filtered by about 1.5 microns of crystal silicon, so that greater than 99% of blue light and about 78% of green light has been absorbed (i.e., only about 0.2% of blue light and about 22% of green light passes), while about 70% of red light remains in photosensor 8; region 8 therefore absorbs primarily red light.

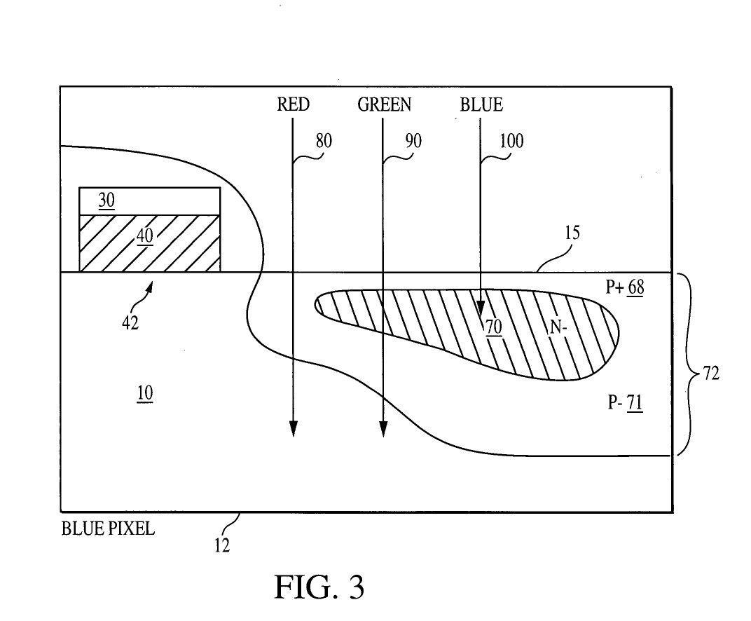

Reference is now made to FIGS. 3-5, which illustrate pixel cells with polysilicon layers of appropriate thicknesses that act as low-pass filters (i.e., filters that transmit frequencies below a given frequency), while each sensing region in a substrate absorbs primarily one non-filtered color and allows other higher wavelength colors to pass.

FIG. 3 depicts a schematic cross-sectional view of a blue pixel 12 for use in a CMOS or CCD image device in accordance with one embodiment of the present invention. Blue pixel 12 can include a shallow photodiode 72 in substrate 10 next to a channel 42 controlled by transfer gate 40. Transfer gate 40 controls transfer of photoelectric charges generated in photodiode 72 through channel 42 to a floating diffusion region (not shown) acting as a sensing node. Transfer gate 40, as well as other gates and device structures (not shown), may be a stacked gate that includes an insulating layer formed over an electrode layer formed in turn over a gate oxide layer, the layers being photolithographically patterned. The electrode layer can, for example, be a polysilicon layer that is also patterned to form wordlines. Layer 30 may optionally be a cap layer of TEOS (tetraethyl orthosilicate), or other suitable coating compound, over transfer gate 40, applied using chemical vapor deposition (CVD), for example, or another deposition technique.

Photodiodc 72 is illustratively a shallow photodiode just beneath the surface 15 of substrate 10. Photodiode 72 can have a suitable depth in substrate 10, so that photodiode 72 absorbs primarily one color, in this case blue light, and allows higher wavelengths to pass. If the substrate is silicon, for example, the photodiode 72 can occupy a region from the substrate surface to a depth of about 10 microns. A shallow photodiode 72 in a silicon substrate could, for example, occupy a region between about 0.1 microns to about 3 microns. Photodiode 72 typically has a photosensitive p-n-p junction region. A lightly doped n-type region 70 is surrounded by a lightly doped p-type region 71, and a heavily doped p-type surface region 68 overlies n-type region 70. An n-doped source/drain region (not shown) is also provided between photodiode 72 and channel 42. A floating diffusion region (not shown) is also formed in substrate 10 on the opposite side of transfer gate 40 from photodiode 72, and can be an n-type region.

As used herein in the description of the invention, the “n” and “p” designations, as in “n-type” and “p-type,” are used in the common manner to designate donor and acceptor type impurities which promote electron and hole type carriers respectively as the majority carriers. The “+” symbol, when used as a suffix with an impurity type should be interpreted to mean that the doping concentration of that impurity is heavier than the doping associated with just the letter identifying the impurity type without the “+” suffix. Conversely, the “−” symbol, when used as a suffix with an impurity type should be interpreted to mean that the doping concentration of that impurity is lighter than the doping associated with just the letter identifying the impurity type without the “−” suffix.

The semiconductor photodiode 72 can mediate unidirectional current flow, as characteristic of diodes used in CMOS chip and imaging devices. Photodiode 72 may also be constructed in a symmetric arrangement and orientation. It should be understood, however, that the invention is applicable to photodiodes in other arrangements and orientation, and with other shapes and geometry, to be integrated with other components of a semiconductor device. CMOS image sensors may optionally include photogates, photoconductors, or other image to charge converting devices, in lieu of photodiodes, for initial accumulation of photo-generated charge.

As shown in the blue pixel 12 illustrated in FIG. 3, blue light 100, representing a large percentage of received photons in the blue wavelength range, is absorbed just beneath the surface 15 of substrate 10 in the region of the pinned photodiode 72, resulting in charge carriers that are stored in photodiode 72 pending readout. Red light 80 and green light 90, each having longer wavelengths as compared to blue light 100, pass deeper into the substrate 10. The charge carriers stored by the photodiode 72 in the blue pixel 12 will be converted to an electrical signal read out by appropriate circuitry described below.

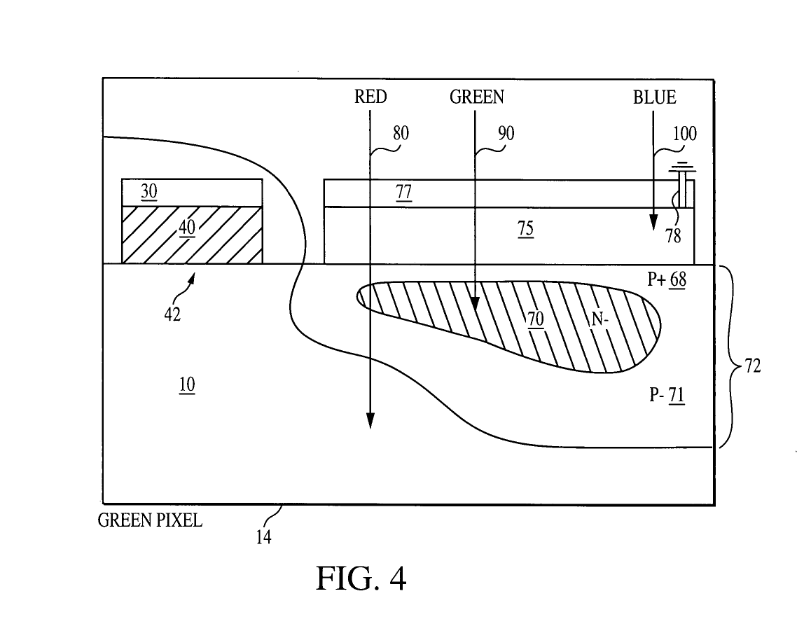

FIG. 4 depicts a schematic cross-sectional view of a green pixel 14 for use in a CMOS or CCD image device in accordance with the first embodiment of the present invention. The structure and function of like-numbered elements as described and set forth above in relation to FIG. 3, such as transfer gate 40 and photodiode 72, also apply to FIG. 4. The green pixel 14 has a photodiode 72 with substantially the same structure as blue pixel 12 as described above. As illustrated in FIG. 4, however, pixel 14 also includes a layer of polysilicon 75 over the photodiode region 72. Polysilicon layer 75 with suitable thickness such as approximately 193 nm is deposited and patterned over pixel 14 to filter out most of the blue light 100 by absorption.

The polysilicon layer 75 acts as a filter to blue light 100, attenuating blue light 100 to nearly zero transmission. Green light 90, representing a large percentage of received photons in the green wavelength range, will pass through the polysilicon layer 75 and into the photodiode 72, while red light 80 will pass much deeper into the substrate 10. Layer 77 may optionally be a cap layer of TEOS (tetraethyl orthosilicate), or other desired coating compound, offer polysilicon layer 75, applied using chemical vapor deposition (CVD), for example. As shown in FIG. 4, the polysilicon filter layer 75 can also have a ground connection 78 to prevent charge buildup.

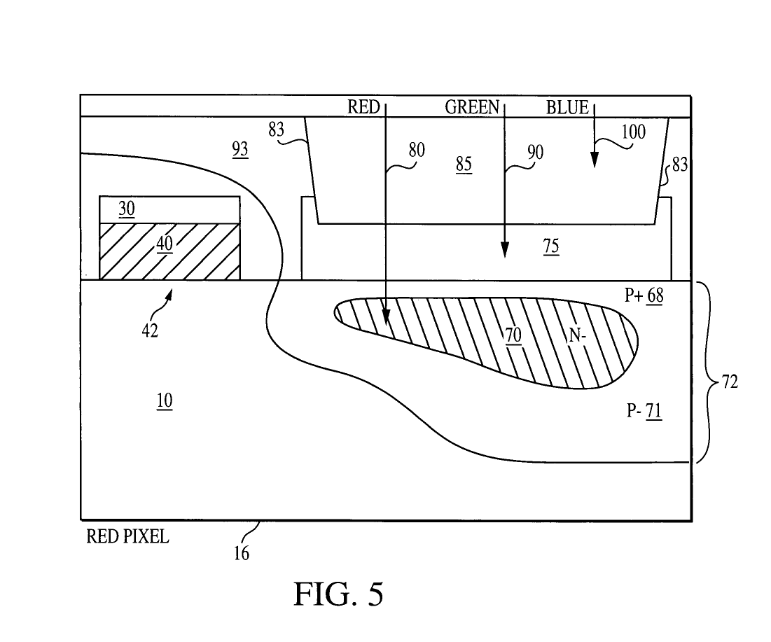

FIG. 5 depicts a schematic cross-sectional view of a red pixel 16 for use in a CMOS or CCD image device in accordance with the first embodiment of the present invention. The structure and function of like-numbered elements as described and set forth above in relation to FIGS. 3 and 4 also apply to FIG. 5. For the red pixel 16, as shown in FIG. 5, polysilicon layers 75 and 85 form the filter. The layer of polysilicon 85 of a suitable thickness, such as approximately 841 nm, is added to filter both blue and green light before it reaches the photodiode 72. The polysilicon filter with layers 75 and 85 will absorb substantially all colors of tight with wavelengths shorter than red. Of the visible wavelengths, only red light will pass through to the underlying photodiode.

Green light 90 and blue light 100 are captured by polysilicon layers 75 and 85, while red light 80, representing a large percentage of received photons in the red wavelength range, passes into the photodiode 72. Although not shown in FIG. 5, the filter on the red pixel can be grounded as in FIG. 4 so that charge does not build up in the filter.

Polysilicon layers 75 and 85 can have optimized thicknesses so that only one set of photodiode implants is required. In an exemplary embodiment with a shallow photodiode and undoped polysilicon, polysilicon layer 75 can have a thickness of approximately 193 nm. This thickness allows approximately 70% of green light to pass while only about 20% of blue light passes. In the same exemplary embodiment, the combined thickness of polysilicon layers 75 and 85 can be approximately 1034 nm. This thickness allows approximately 70% or red light to pass, while only approximately 15% of green light and approximately 1% of blue light pass. These percentage transmission values are only exemplary values that can be obtained, and other thicknesses could be used to obtain other percentages.

Each of the structures shown in FIGS. 3-5 may be covered with a translucent or transparent insulating layer (not shown) formed over the CMOS image device. Such an insulating layer is typically SiO₂, BPSU, PSG, BSG, BPSG or SOG which is planarized. Conventional processing steps may also be carried out to form, for example, contacts in the insulating layer to provide electrical connection with the implanted source/drain regions and other wiring to connect gate lines and other connections in the pixel. The contact holes may be metallized to provide electrical contact to a photogate, reset gate and transfer gate.

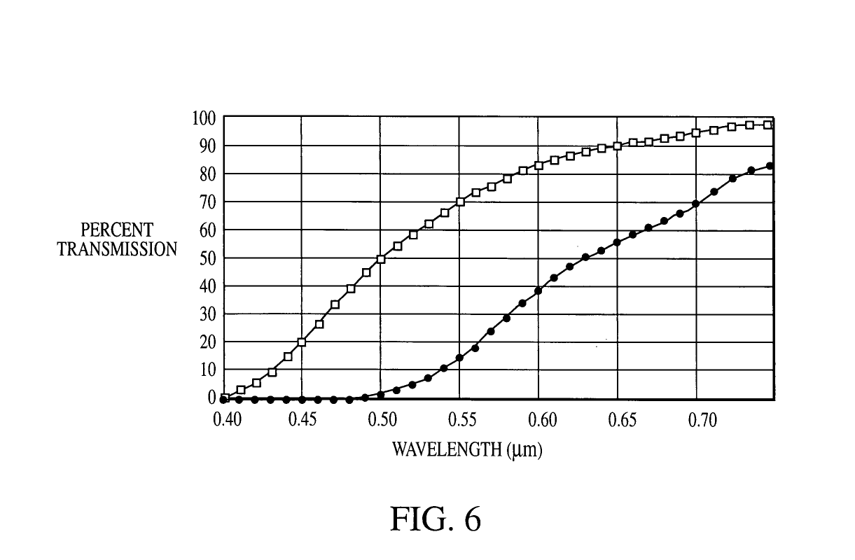

FIG. 6 illustrates the approximate percentage of light transmitted into photodiode 72 in pixels 14 and 16 as a function of wavelength of incident light. The upper curve, with open squares, represents percentages of light (all light, not just green) that enters green pixel 14 after being attenuated by a polysilicon filter of approximate 193 nm thickness. The lower curve, with closed (dark) circles, represents percentages of light that pass through a polysilicon filter of approximately 1034 nm and enter red pixel 16.

Reference is now made to FIGS. 7-10 which relate to epitaxial crystal silicon layers of appropriate thicknesses that act as low-pass filters (i.e., filters that transmit frequencies below a given frequency). The structures of FIG. 7-9 differ in part from the structures of FIGS. 3-5 in that the structures of FIGS. 3-5 illustrate polysilicon structures, whereas the structures of FIGS. 7-9 illustrate epitaxial crystal silicon structures.

FIG. 7 depicts a schematic cross-sectional view of a blue pixel 112 for use in a CMOS or CCD image device in accordance with the second embodiment of the present invention. Blue pixel 112 can include a shallow photodiode 72 in substrate 10 next to a channel 42 controlled by transfer gate 40. As shown in the blue pixel 112 of FIG. 7, blue light 100, representing a large percentage of received photons in the blue wavelength range, is absorbed just beneath the surface 15 of substrate 10 in the region of the pinned photodiode 72, resulting in charge carriers that are stored in photodiode 72 pending readout. Red light 80 and green light 90, each having longer wavelengths as compared to blue light 100, pass deeper into the substrate 10. The charge carriers stored by the photodiode 72 in the blue pixel 12 will be converted to an electrical signal read out by appropriate circuitry described below.

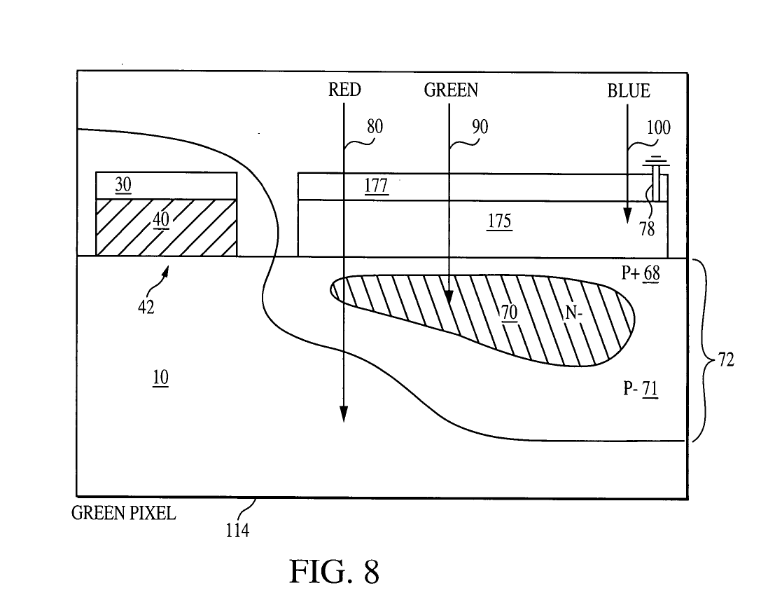

FIG. 8 depicts a schematic cross-sectional view of a green pixel 114 for use in a CMOS or CCD image device in accordance with the second embodiment of the present invention. Pixel 114 includes a layer 175 of epitaxial crystal silicon over the photodiode region 72. Epitaxial crystal silicon layer 175 with suitable thickness, such as about 300 nm for example, is deposited and patterned over pixel 114 to filter out most of the blue light 100 by absorption.

The epitaxial crystal silicon layer 175 acts as a filter to blue light 100, attenuating blue light 100 to nearly zero transmission. Green light 90, representing a large percentage of received photons in the green wavelength range, will pass through the epitaxial crystal silicon layer 175 and into the photodiode 72, while red light 80 will pass much deeper into the substrate 10. Layer 77 may optionally be a cap layer of TEOS (tetraethyl orthosilicate), or other desired coating compound, over epitaxial crystal silicon layer 175, applied using chemical vapor deposition (CVD), for example.

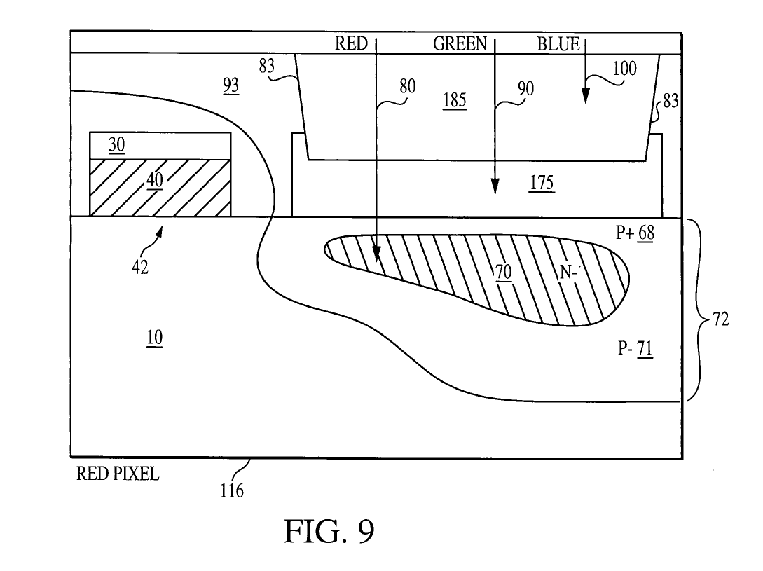

FIG. 9 illustrates a schematic cross-sectional view of a red pixel 116 for use in a CMOS or CCD image device in accordance with the second embodiment of the present invention. For the red pixel 116 of FIG. 9, epitaxial crystal silicon layers 175 and 185 form the filter. The layer of epitaxial crystal silicon 185 of a suitable thickness, such as approximately 841 nm, is added to filter both blue and green light before it reaches the photodiode 72. The epitaxial crystal silicon filter with layers 175 and 185 will absorb substantially all colors of light with wavelengths shorter than red. Of the visible wavelengths, only red light will pass through to the underlying photodiode.

Green light 90 and blue light 100 arc captured by epitaxial crystal silicon layers 175 and 185, while red light 80, representing a large percentage of received photons in the red wavelength range, passes into the photodiode 72. Although not shown in FIG. 9, the filter on the red pixel can be grounded as in FIG. 8 so that charge does not build up in the filter.

As in the previous embodiment described above with reference to polysilicon layers 75 and 85, the epitaxial crystal silicon layers 175 and 185 can have optimized thicknesses so that only one set of photodiode implants is required. In an exemplary embodiment with a shallow photodiode and epitaxial crystal silicon, epitaxial crystal silicon layer 175 can have a thickness of approximately 300 nm. This thickness allows approximately 74% of green light to pass while only about 29% of blue light passes. In the same exemplary embodiment, the combined thickness of epitaxial crystal silicon layers 175 and 185 can be approximately 1500 nm. This thickness allows approximately 70% of red light to pass, while only approximately 22% of green light and approximately 0.2% of blue light pass. These percentage transmission values are only exemplary values that can be obtained, and other thicknesses could be used to obtain other percentages.

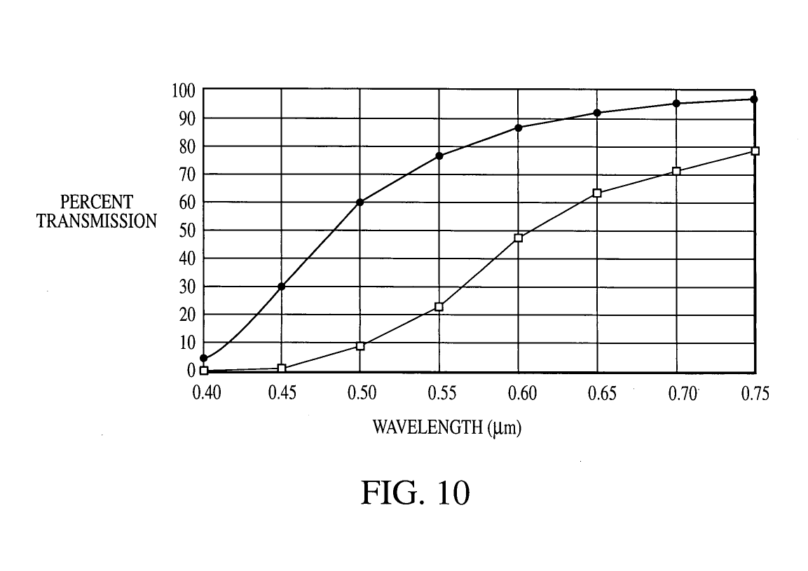

FIG. 10 is a graph illustrating the percentage of light transmitted as a function of wavelength of incident light for the pixels formed using epitaxial crystal silicon. The upper curve, with dark circles, represents percentages of light (all light, not just green) that enters the green pixel after being attenuated by a epitaxial crystal silicon filter. The lower curve, with open squares, represents percentages of light that pass through a epitaxial crystal silicon filter and enter the red pixel.

The techniques described above in relation to FIGS. 3-10 can be used to produce improved imager integrated circuits (ICs), such as CMOS imager ICs. Currently most CMOS imager ICs use a colored filter array (CFA) such as that shown in FIG. 1. The CFA is typically located above metal layers, and its fabrication typically requires four mask layers (one each for blue, red, green and clear coat). Each mask layer is photolithographically patterned to allow deposition of filter material only over the relevant pixels. The use of four different masking operations, however, often results in contamination from Na, Cu and other elements in CFA materials.

The techniques of FIGS. 3-10 make it possible to reduce the number of masking operations used to produce blue, red, and green pixel filters for an array of pixels. By depositing and patterning polysilicon layers of suitable thicknesses, an appropriate stacked polysilicon filter can be formed over each pixel sensor area that requires one. Each thickness of the filter will be determined by the thicknesses of layers that are present in it, with each additional layer causing absorption of the majority of light at a longer wavelength. Because of its thickness, each pixel's filter absorbs wavelengths shorter than the wavelengths the pixel senses, and the pixel itself transmits longer wavelengths.

In one exemplary fabrication method (corresponding to the first embodiment of FIGS. 3-6), polysilicon layer 75 is deposited to a thickness of approximately 193 nm. Polysilicon layer 75 may be deposited by any suitable technique, e.g., using chemical vapor deposition (CVD) techniques such as low pressure chemical vapor deposition (LPCVD) or high density plasma (HDP) deposition.

A first layer of photoresist is then deposited over polysilicon layer 75, exposed with an appropriate mask, and developed to produce a resist layer in which polysilicon layer 75 is exposed except over sensing areas of green and red pixels. The exposed portions of polysilicon layer 75 are then etched away, leaving a part of polysilicon layer 75 over each green pixel 14 and each red pixel 16 but not over each blue pixel 12. Appropriate operations can then be performed to prepare exposed surfaces for further operations.

Polysilicon layer 85 is then deposited over the resist layer to a thickness of approximately 841 nm. Like layer 75, layer 85 may be deposited by any suitable technique, including those described above. A second layer of photoresist is then deposited, exposed with an appropriate mask, and developed to produce a resist layer that exposes only sensing areas of red pixels. The portions of polysilicon layer 85 that are over the resist layer are then removed by liftoff techniques, leaving a part of polysilicon layer 85 over each red pixel 16 but not over each blue pixel 12 or each green pixel 14.

Instead of depositing polysilicon layer 85 before BPSG (boro-phospho-silicate glass) layer 93 shown in FIG. 5, deposition could be done after a photolithographically patterned plug etch. In one embodiment, such a plug etch can form an opening between sidewalls 83 through which polysilicon can be deposited.

In addition to polysilicon layers 75 and 85, other polysilicon layers can be included in an array, such as a layer in which wordlines are formed and a layer in which top cell plates are formed. If polysilicon wordlines and top cell plates (not shown) extend over photodiode 72, high doping can make these optional polysilicon layers nearly transparent to blue light 100 (as well as light of longer wavelengths).

After production of pixels and polysilicon pixel filters in an array, the array may be covered with a series of translucent or transparent insulating and protective layers (not shown). Such layers might include such materials as SiO₂, BPSU, PSG, BSG, SOB, BPSG, or TEOS, any of which could be planarized as appropriate. Additional conventional processing steps may be carried out to form, for example, contact holes through the insulating layers to provide electrical connections with source/drain regions and other wiring to connect gate lines, such as for a photogate, reset gate, and transfer gate, and other connections in the pixel, and to ground polysilicon filters as illustrated in FIG. 4. Contact holes may be metallized to provide electrical connections.

The deposition and patterning of polysilicon filters in layers 75 and 85 can be performed to cover as much of the pixel array as possible to a suitable thickness for blocking non-normally incident light. This may reduce cross talk by reducing the number of errant photons that enter a pixel's photodiode 72 from directions other than directly perpendicular to surface 15 of substrate 10. Diminished cross talk may also reduce or eliminate the need for light blocking metal layers.

In yet another exemplary fabrication method (corresponding to the second embodiment of FIGS. 7-10), epitaxial silicon layers 175, 185 may be grown over the photodiode 72 using any suitable technique, for example using a ultra high vacuum (UHV) reactor under low pressure and temperature conditions. Other techniques, including for example chemical vapor deposition (CVD), Vapor Phase Epitaxy or Liquid Phase Epitaxy (LPE) techniques may also be used for the epitaxial growth of silicon on a substrate. Experimental conditions may be varied as required, including variation of temperature and annealing conditions. For example, annealing in the range of 930-950° C. for 2 hours under H₂ flow may be utilized prior to epitaxial silicon growth. The epitaxial filter may be grounded to not build up charge.

Epitaxial silicon layers 175, 185 can be formed with optimized thicknesses over the photodiode 72 to filter unwanted photon energies, acting as a filter to blue light, and attenuating blue light to near zero transmission. As noted above, the photosensor may, for example, receive light filtered by about 300 nm of epitaxial crystal silicon, so that about 70% of blue light has been absorbed by the filter while about 74% of green light remains in the photodiode 72.

The above fabrication method could be included in a wide variety of overall fabrication processes for arrays. Photodiode region 72 in each pixel could be produced by a series of doping operations, some performed before, some during, and some after production of polysilicon pixel filters. Similarly, gates and source/drain regions for n-channel transistors in a pixel array and p-channel transistors in peripheral circuitry could be produced by operations that are performed before, during, or after production of polysilicon or epitaxial crystal silicon pixel filters. In general, process steps may be varied as is required or convenient for a particular process flow.

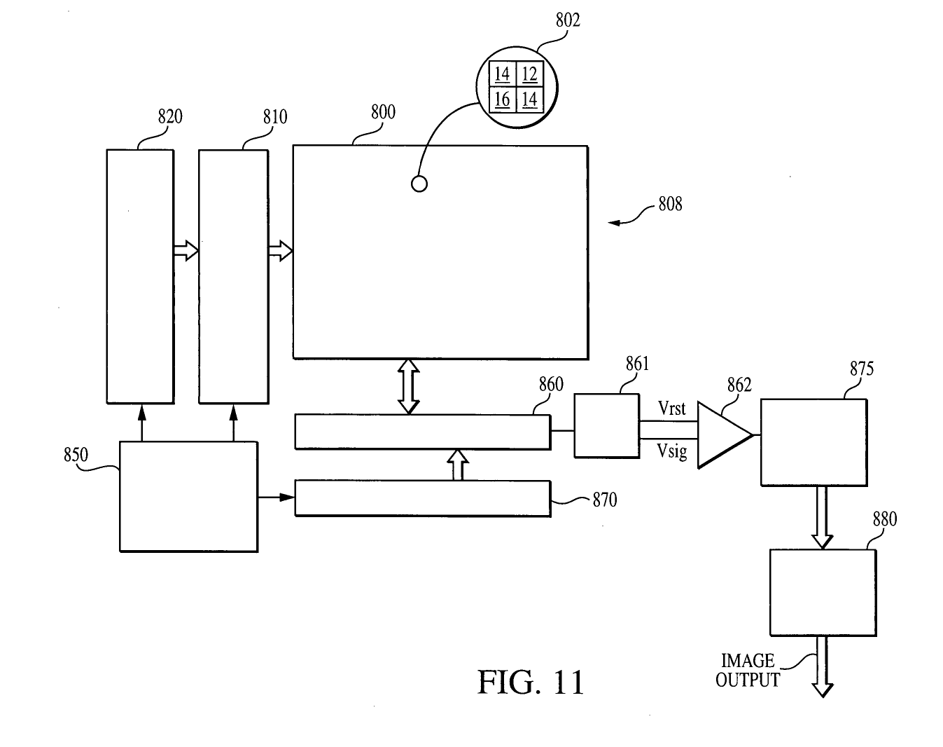

The above description of fabrication methods is only illustrative. The techniques of FIGS. 3-10 could be implemented with a wide variety of fabrication technologies. Substrate 10, as shown in FIGS. 3-5 and 7-9, may be the substrate of an integrated circuit that includes a complete array of pixels for an imager, such as a CMOS, CCD, or hybrid imager. In addition, other circuitry can be formed on substrate 10, such as circuitry for reading out signals from pixels in the array, as described below in relation to FIG. 11.

FIG. 11 illustrates a block diagram of a CMOS imager integrated circuit (IC) 808 having a pixel array 800 containing a plurality of pixels arranged in rows and columns, including a region 802 with, for example, two green pixels 14 as in FIG. 4, one blue pixel 12 as in FIG. 3, and one red pixel 16 as in FIG. 5. The pixels of each row in array 800 are all turned on at the same time by a row select line (not shown), and the pixels of each column are selectively output by respective column select lines (not shown).

The row lines are selectively activated by a row driver 810 in response to row address decoder 820. The column select lines are selectively activated by a column selector 860 in response to column address decoder 870. The pixel array is operated by the timing and control circuit 850, which controls address decoders 820, 870 for selecting the appropriate row and column lines for pixel signal readout.

The pixel column signals, which typically include a pixel reset signal (Vᵣₛₜ) and a pixel image signal (V_{sig}), are read by a sample and hold circuit 861 associated with the column selector 860. A differential signal (Vᵣₛₜ-V_{sig}) is produced by differential amplifier 862 for each pixel which is amplified and digitized by analog to digital converter 875 (ADC). The analog to digital converter 875 supplies the digitized pixel signals to an image processor 880 which can perform image processing in which signals read out from blue pixels 12 are treated as levels of blue light intensity, signals read out from green pixels 14 are treated as levels of green light intensity, and signals from red pixels 16 are treated as levels of red light intensity. The resulting red, green and blue pixel values can be provided to other components to define an RGB output image.

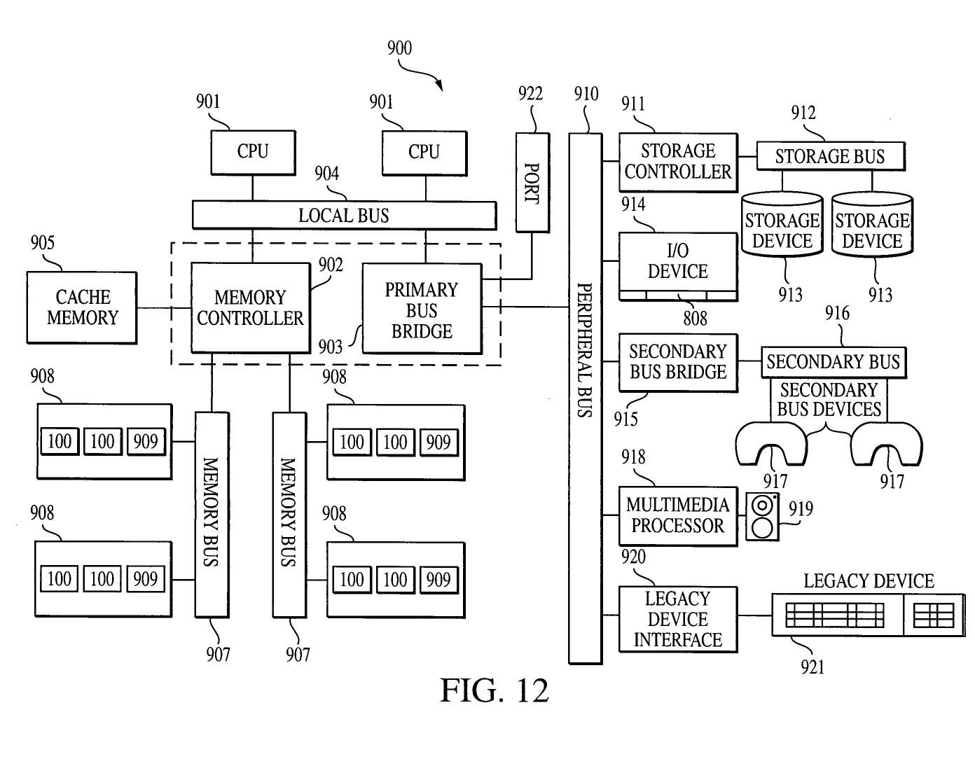

If desired, the imaging device 808 described above with respect to FIG. 11 may be combined with other components in a single integrated circuit. FIG. 12 illustrates an exemplary processing system 900 which may include CMOS imager IC 808 or another imaging device incorporating features illustrated in FIGS. 3-9.

As illustrated in FIG. 11, the processing system 900 includes one or more processors 901 coupled to a local bus 904. A memory controller 902 and a primary bus bridge 903 are also coupled to local bus 904. The processing system 900 may include multiple memory controllers 902 and/or multiple primary bus bridges 903. The memory controller 902 and the primary bus bridge 903 may be integrated as a single device 906.

The memory controller 902 is also coupled to one or more memory buses 907. Each memory bus accepts memory components 908 which include at least one memory device 100. The memory components 908 may be a memory card or a memory module. Examples of memory modules include single inline memory modules (SIMMs) and dual inline memory modules (DIMMs). The memory components 908 may include one or more additional devices 909. For example, in a SIMM or DIMM, the additional device 909 might be a configuration memory, such as a serial presence detect (SPD) memory. The memory controller 902 may also be coupled to a cache memory 905. The cache memory 905 may be the only cache memory in the processing system. Alternatively, other devices, for example, processors 901 may also include cache memories, which may form a cache hierarchy with cache memory 905. If the processing system 900 includes peripherals or controllers which are bus masters or which support direct memory access (DMA), the memory controller 902 may implement a cache coherency protocol. If the memory controller 902 is coupled to a plurality of memory buses 907, each memory bus 907 may be operated in parallel, or different address ranges may be mapped to different memory buses 907.

The primary bus bridge 903 is coupled to at least one peripheral bus 910. Various devices, such as peripherals or additional bus bridges may be coupled to the peripheral bus 910. These devices may include a storage controller 911, miscellaneous I/O device 914, a secondary bus bridge 915, a multimedia processor 918, and legacy device interface 920. The primary bus bridge 903 may also be coupled to one or more special purpose high speed ports 922. In a personal computer, for example, the special purpose port might be the Accelerated Graphics Port (AGP), used to couple a high performance video card to the processing system 900.

The storage controller 911 couples one or more storage devices 913, via a storage bus 912, to the peripheral bus 910. For example, the storage controller 911 may be a SCSI controller and storage devices 913 may be SCSI discs. The I/O device 914 may be an imaging device that includes CMOS imager IC 808. System 900 could include any other sort of I/O peripheral device. For example, the I/O device 914 may be a local area network interface, such as an Ethernet card. The secondary bus bridge may be used to interface additional devices via another bus to the processing system. For example, the secondary bus bridge may be a universal serial port (USB) controller used to couple USB devices 917 via to the processing system 900. The multimedia processor 918 may be a sound card, a video capture card, or any other type of media interface, which may also be coupled to additional devices such as speakers 919. The legacy device interface 920 is used to couple legacy devices, for example, older styled keyboards and mice, to the processing system 900.

The processing system 900 illustrated in FIG. 11 is only an exemplary processing system with which the invention may be used. While FIG. 11 illustrates a processing architecture especially suitable for a general purpose computer, such as a workstation, it should be recognized that well known modifications can be made to configure the processing system 900 to become more suitable for use in a variety of applications. For example, many electronic devices which require processing may be implemented using a simpler architecture which relies on a CPU 901 coupled to memory components 908 and/or memory devices 100. These electronic devices may include, but are not limited to audio/video processors and recorders, gaming consoles, digital television sets, wired or wireless telephones, navigation devices (including system based on the global positioning system (GPS) and/or inertial navigation), and digital cameras and/or recorders. CMOS imager devices that include embodiments of the present invention, when coupled to a pixel processor, for example, may be implemented in color or monochrome digital cameras and video processors and recorders. Modifications may include, for example, elimination of unnecessary components, addition of specialized devices or circuits, and/or integration of a plurality of devices.

While the above-described embodiments of the invention relate to CMOS and CCD imager devices with polysilicon filters, one skilled in the art will recognize that the broad scope of the invention includes various other types of imager devices separately or integrated with one or more processing components in a semiconductor device. For example, although the invention is described above for use in a CMOS image sensor, the broad scope of the invention is not limited to such and may be applicable to any suitable image sensor, for example, CCD image sensors. Similarly, the above-described embodiments include polysilicon filters of particular thicknesses, but the broad scope of the invention includes other thicknesses and other materials that can senre as filters, whether for red, green and blue, or for other colors. The above-described array embodiments include red, green, and blue pixels, but monochrome or dichrome arrays or other multichrome arrays with these or other wavelength ranges in the visible or invisible EM spectrum could also be implemented with embodiments of the invention.

The last (output) stage of a CCD image sensor provides sequential pixel signals as output signals, and uses a floating diffusion node, source follower transistor, and reset gate in a similar manner to the way these elements are used in the pixel of a CMOS imager. Accordingly, the pixels formed using the polysilicon filters as described above may be employed in CCD image sensors as well as CMOS image sensors. The imager devices described above may also be formed at different sizes, for example, as imagers having arrays in the range of about 128 kilopixels to about 11 megapixels.

Further, the above-described embodiments of the invention include CMOS pixels with shallow buried photodiodes. The broad scope could include other types of photosensitive elements in other configurations. Similarly, the fabrication method described above is but one method of many that may be used.

The above description and drawings illustrate embodiments which achieve the objects of the present invention. Although certain advantages and embodiments have been described above, those skilled in the art will recognize that substitutions, additions, deletions, modifications and/or other changes may be made without departing from the spirit or scope of the invention. Accordingly, the invention is not limited by the foregoing description but is only limited by the scope of the appended claims.

1. A sensing device comprising:
a substrate;
a sensing region at a surface of the substrate that receives incident light, the sensing region absorbing a majority of incident light at wavelengths shorter than an upper wavelength and transmitting a majority of incident tight at wavelengths longer than the banding wavelength;
a filter structure over the sensing region that filters incident light before it reaches the sensing region; the filter structure absorbing a majority of incident light at wavelengths shorter than a lower wavelength and transmitting a majority of incident light at wavelengths longer than the lower wavelength; and
readout circuitry at the surface of the substrate that provides readout signals indicating a quantity of incident light absorbed in the sensing region.

2. The sensing device of claim 1, wherein the filter structure comprises a polysilicon filter.

3. The sensing device of claim 1, wherein the filter structure comprises an epitaxial silicon filter.

4. The sensing device of claim 1, wherein the lower wavelength is approximately between blue and green visible light, and the upper wavelength is approximately between green and red visible light.

5. The sensing device of claim 4, wherein the lower wavelength is approximately between green and red visible light, and the upper wavelength is longer than red visible light.

6. The sensing device of claim 1, wherein the filter structure is photolithographically patterned.

7. The sensing device of claim 1, wherein the filter structure blocks non-normally incident light.

8. An integrated circuit comprising:
a substrate;
a pixel array, each of a set of pixels in the pixel array comprising:
a photosensor at or beneath a surface of the substrate; and
a filter comprising polysilicon or epitaxial silicon over said photosensor, the filter absorbing a majority of light at wavelengths shorter than a first wavelength and transmitting a majority of light at wavelengths longer than the first wavelength;
the photosensor receiving light transmitted by the filter, absorbing a majority of light received at wavelengths shorter than a second wavelength and longer than the first wavelength, and transmitting a majority of light received at wavelengths longer than the second wavelength.

9. A sensing device comprising:
a substrate;
a sensing region at a surface of the substrate that receives incident light, the sensing region absorbing a majority of incident light at wavelengths shorter than a bounding wavelength and transmitting a majority of incident light at wavelengths longer than the bounding wavelength; and
readout circuitry at the surface of the substrate that provides readout signals indicating a quantity of incident light absorbed in the sensing region.

10. The sensing device of claim 9, wherein the bounding wavelength is approximately between blue and green visible light.

11. An image pixel array in an imaging device, comprising:
at least one a photosensor at or beneath a surface of a substrate; and
a filter comprising polysilicon or epitaxial silicon layer over said photosensor, the filter absorbing a majority of light at wavelengths shorter than a first wavelength and transmitting a majority of tight at wavelengths longer than the first wavelength;
the photosensor receiving light transmitted by the filter, absorbing a majority of light received at wavelengths shorter than a second wavelength and longer than the first wavelength, and transmitting a majority of light received at wavelengths longer than the second wavelength.

12. The image pixel array of claim 11, wherein said at least one photosensor is formed beneath an upper surface of said substrate.

13. The image pixel array of claim 12, wherein said photosensor is selected from the group consisting of a photo diode, photogate, photoconductor, or other image to charge converting device for initial accumulation of photo-generated charge.

14. The image pixel array of claim 11, wherein said polysilicon or epitaxial silicon layer is formed to attenuate only light having a wavelength of blue light.

15. The image pixel array of claim 11, wherein said polysilicon or epitaxial silicon layer is formed to attenuate light having a wavelength of blue light and light having a wavelength of green light.

16. The image pixel array of claim 11, wherein a layer of tetraethyl orthosilicate is formed over said polysilicon or epitaxial silicon layer.

17. The image pixel array of claim 11, wherein a second layer of polysilicon is formed over said polysilicon or epitaxial silicon layer.

18. The image pixel array of claim 11, wherein an insulating layer is formed over said polysilicon or epitaxial silicon layer.

19. The image pixel array of claim 18, wherein electrical contacts are formed in said insulating layer.

20. The image pixel array of claim 11, wherein said pixel array is formed of about 1.3 megapixels to about 4 megapixels.

21. The image pixel array of claim 11, wherein the filter blocks non-normally incident light.

22. An image pixel array in an imaging device, comprising:
a plurality of photosensors at a surface of a substrate, said plurality comprising a first set, second set and third set of photosensors;
a first polysilicon filter over each of said first set of photosensors, said first polysilicon filter comprising part of a first patterned layer of polysilicon over the photosensor;
a second polysilicon filter over each of said second set of photosensors, said second polysilicon filter comprising part of the first patterned layer over the photosensor and part of a second patterned layer of polysilicon over said first patterned layer; and
readout circuitry at the substrate's surface that provides readout signals indicating a quantity of incident light absorbed in the photosensors;
each first polysilicon filter absorbing a majority of light at wavelengths shorter than a first wavelength and transmitting a majority of tight at wavelengths longer than the first wavelength;
each of the first set of photosensors receiving light transmitted by the first polysilicon filter, absorbing a majority of light received at wavelengths shorter than a second wavelength and longer than the first wavelength, and transmitting a majority of light received at wavelengths longer than the second wavelength;
each second polysilicon filter absorbing a majority of light at wavelengths shorter than a third wavelength approximately equal to the second wavelength and transmitting a majority of light at wavelengths longer than the third wavelength;
each of the second set of photosensors receiving light transmitted by the second polysilicon filter, absorbing a majority of light received at wavelengths shorter than a fourth wavelength and longer than the third wavelength, and transmitting a majority of light received at wavelengths longer than the fourth wavelength; and
each of the third set of photosensors absorbing a majority of light received at wavelengths shorter than a fifth wavelength approximately equal to the first wavelength, and transmitting a majority of light received at wavelengths longer than the fifth wavelength.

23. An image pixel array in an imaging device, comprising:
a plurality of photosensors at a surface of a substrate, said plurality comprising a first set, second set and third set of photosensors;
a first epitaxial silicon filter over each of said first set of photosensors, said first epitaxial silicon filter comprising part of a first patterned layer of epitaxial silicon over the photosensor;
a second epitaxial silicon filter over each of said second set of photosensors, said second epitaxial silicon filter comprising part of the first patterned layer over the photosensor and part of a second patterned layer of epitaxial silicon over said first patterned layer; and
readout circuitry at the substrate's surface that provides readout signals indicating a quantity of incident light absorbed in the photosensors;
each first epitaxial silicon filter absorbing a majority of light at wavelengths shorter than a first wavelength and transmitting a majority of light at wavelengths longer than the first wavelength;
each of the first set of photosensors receiving light transmitted by the first epitaxial silicon filter, absorbing a majority of light received at wavelengths shorter than a second wavelength and longer than the first wavelength, and transmitting a majority of light received at wavelengths longer than the second wavelength;
each second epitaxial silicon filter absorbing a majority of light at wavelengths shorter than a third wavelength approximately equal to the second wavelength and transmitting a majority of light at wavelengths longer than the third wavelength;
each of the second set of photosensors receiving light transmitted by the second epitaxial silicon filter, absorbing a majority of light received at wavelengths shorter than a fourth wavelength and longer than the third wavelength, and transmitting a majority of light received at wavelengths longer than the fourth wavelength; and
each of the third set of photosensors absorbing a majority of light received at wavelengths shorter than a fifth wavelength approximately equal to the first wavelength, and transmitting a majority of light received at wavelengths longer than the fifth wavelength.

24. An imager system, comprising:
a processor; and
an imaging device coupled to said processor, said imaging device comprising:
a semiconductor substrate; and
a pixel array, said pixel array comprising:
at least one photosensor at or beneath a surface of a substrate; and
a polysilicon filter over said photosensor, the polysilicon filter absorbing a majority of light at wavelengths shorter than a first wavelength and transmitting a majority of light at wavelengths longer than the first wavelength;
the photosensor receiving light transmitted by the polysilicon filter, absorbing a majority of light received at wavelengths shorter than a second wavelength and longer than the first wavelength, and transmitting a majority of light received at wavelengths longer than the second wavelength.

25. An imager system, comprising:
a processor; and
an imaging device coupled to said processor, said imaging device comprising:
a semiconductor substrate; and
a pixel array, said pixel array comprising:
at least one photosensor at or beneath a surface of a substrate; and
an epitaxial silicon filter over said photosensor, the epitaxial silicon filter absorbing a majority of light at wavelengths shorter than a first wavelength and transmitting a majority of light at wavelengths longer than the first wavelength;
the photosensor receiving light transmitted by the epitaxial silicon filter, absorbing a majority of light received at wavelengths shorter than a second wavelength and longer than the first wavelength, and transmitting a majority of light received at wavelengths longer than the second wavelength.

26. An integrated circuit comprising:
a substrate;
a pixel array, each of a set of pixels in the pixel array comprising:
a photosensor at or beneath a surface of the substrate; and
a crystal silicon filter over said photosensor, the crystal silicon filter absorbing a majority of light at wavelengths shorter than a first wavelength and transmitting a majority of light at wavelengths longer than the first wavelength;
the photosensor receiving tight transmitted by the crystal silicon filter, absorbing a majority of light received at wavelengths shorter than a second wavelength and longer than the first wavelength, and transmitting a majority of light received at wavelengths longer than the second wavelength.

27. An image pixel array in an imaging device, comprising:
at least one a photosensor at or beneath a surface of a substrate; and
a crystal silicon filter over said photosensor, the crystal silicon filter absorbing a majority of light at wavelengths shorter than a first wavelength and transmitting a majority of light at wavelengths longer than the first wavelength;
the photosensor receiving light transmitted by the crystal silicon filter, absorbing a majority of light received at wavelengths shorter than a second wavelength and longer than the first wavelength, and transmitting a majority of light received at wavelengths longer than the second wavelength.

28. An image pixel array in an imaging device, comprising:
a plurality of photosensors at a surface of a substrate, said plurality comprising a first set, second set and third set of photosensors;
a first crystal silicon filter over each of said first set of photosensors, said first crystal silicon filter comprising part of a first patterned layer of epitaxial crystal silicon over the photosensor;
a second crystal silicon filter over each of said second set of photosensors, said second crystal silicon filter comprising part of the first patterned layer over the photosensor and part of a second patterned layer of epitaxial crystal silicon over said first patterned layer; and
readout circuitry at the substrate's surface that provides readout signals indicating a quantity of incident light absorbed in the photosensors;
each first crystal silicon filter absorbing a majority of light at wavelengths shorter than a first wavelength and transmitting a majority of light at wavelengths longer than the first wavelength;
each of the first set of photosensors receiving light transmitted by the first crystal silicon filter, absorbing a majority of light received at wavelengths shorter than a second wavelength and longer than the first wavelength, and transmitting a majority of light received at wavelengths longer than the second wavelength;
each second crystal silicon filter absorbing a majority of light at wavelengths shorter than a third wavelength approximately equal to the second wavelength and transmitting a majority of light at wavelengths longer than the third wavelength;
each of the second set of photosensors receiving light transmitted by the second crystal silicon filter, absorbing a majority of light received at wavelengths shorter than a fourth wavelength and longer than the third wavelength, and transmitting a majority of light received at wavelengths longer than the fourth wavelength; and
each of the third set of photosensors absorbing a majority of light received at wavelengths shorter than a fifth wavelength approximately equal to the first wavelength, and transmitting a majority of light received at wavelengths longer than the fifth wavelength.

29. An imager system, comprising:
a processor; and
an imaging device coupled to said processor, said imaging device comprising:
a semiconductor substrate; and
a pixel array, said pixel array comprising:
at least one photosensor at or beneath a surface of a substrate; and
a crystal silicon filter over said photosensor, the crystal silicon filter absorbing a majority of light at wavelengths shorter than a first wavelength and transmitting a majority of light at wavelengths longer than the first wavelength;
the photosensor receiving light transmitted by the crystal silicon filter, absorbing a majority of light received at wavelengths shorter than a second wavelength and longer than the first wavelength, and transmitting a majority of light received at wavelengths longer than the second wavelength.

30. An imager integrated circuit, comprising:
a substrate;
a pixel array at the substrate's surface, the pixel array comprising:
first and second sets of pixels, each including a photosensor;
a first polysilicon filter over each of said first set of photosensors, said first polysilicon filter absorbing a majority of light at wavelengths shorter than a first wavelength and transmitting a majority of light at wavelengths longer than the first wavelength;
a second polysilicon filter over each of said second set of photosensors, said second polysilicon filter absorbing a majority of light at wavelengths shorter than a second wavelength longer than the first wavelength and transmitting a majority of light at wavelengths longer than the second wavelength; and
readout circuitry at the substrate's surface that provides readout signals indicating a quantity of incident light absorbed in each of the photosensors.

31. An imager integrated circuit, comprising:
a substrate;
a pixel array at the substrate's surface, the pixel array comprising:
first and second sets of pixels, each including a photosensor;
a first crystal silicon filter over each of said first set of photosensors, said first crystal silicon filter absorbing a majority of light at wavelengths shorter than a first wavelength and transmitting a majority of light at wavelengths longer than the first wavelength;
a second crystal silicon filter over each of said second set of photosensors, said second crystal silicon filter absorbing a majority of light at wavelengths shorter than a second wavelength longer than the first wavelength and transmitting a majority of light at wavelengths longer than the second wavelength; and
readout circuitry at the substrate's surface that provides readout signals indicating a quantity of incident light absorbed in each of the photosensors.

32. A method of forming a sensing device that senses light in a wavelength range, comprising:
forming a photosensor at or beneath a surface of a substrate; and
providing a filter formed of polysilicon or epitaxial silicon over said photosensor, the filter absorbing a majority of light at wavelengths shorter than a first wavelength and transmitting a majority of light at wavelengths longer than the first wavelength;
the photosensor receiving light transmitted by the filter, absorbing a majority of light received at wavelengths shorter than a second wavelength and longer than the first wavelength, and transmitting a majority of light received at wavelengths longer than the second wavelength.

33. The method of claim 32, wherein said photosensor is formed beneath the surface of said substrate.

34. The method of claim 32, wherein said photosensor is selected from the group consisting of a photodiode, photogate, photoconductor, or other image to charge converting device.

35. The method of claim 32, wherein the first wavelength is approximately between blue and green visible light.

36. The method of claim 32, wherein the first wavelength is approximately between green and red visible light.

37. The method of claim 32, wherein the second wavelength is approximately between green and red visible light.

38. The method of claim 32, wherein the second wavelength is longer than red visible light.

39. The method of claim 32, further comprising forming a layer of insulating material over said filter.

40. The method of claim 32, wherein the act of forming the filter comprises:
depositing a first layer of polysilicon or epitaxial silicon over the photosensor; and
patterning the first layer of polysilicon or epitaxial silicon.

41. The method of claim 32, wherein the act of forming the filter comprises:
forming a first patterned layer of polysilicon or epitaxial silicon that includes a first portion over the photosensor; and
forming a second patterned layer of polysilicon or epitaxial silicon that includes a second portion on the first portion.

42. The method of claim 32, wherein said filter is a polysilicon filter.

43. The method of claim 42, wherein said polysilicon filter is formed at a thickness of about 193 nm.

44. The method of claim 42, wherein said polysilicon filter is formed at a thickness of about 1034 nm.

45. The method of claim 32, wherein said filter is an epitaxial silicon filter.

46. The method of claim 45, wherein said epitaxial silicon filter is formed at a thickness of about 300 nm.

47. The method or claim 45, wherein said epitaxial silicon filter is formed at a thickness of about 1500 nm.

48. The method of claim 32, wherein said filter is formed to a thickness suitable for blocking non-normally incident light.

49. A method of sensing light in a range between lower and upper wavelengths comprising:
passing light through a filter structure that absorbs a majority of light at wavelengths shorter than the lower wavelength and transmits a majority of light at wavelengths longer than the lower wavelength; and
sensing light transmitted by the filter structure in a sensing structure, the sensing structure including a sensing region that absorbs a majority of light at wavelengths shorter than the upper wavelength, wherein the sensing structure provides an output signal in response to light absorbed in the sensing region.

50. The method of claim 49, wherein the sensing structure is a substrate, the sensing region being at a surface of the substrate, the filter structure being photolithographically patterned on the substrate's surface.

51. The method of claim 49, wherein the sensing structure provides an output signal in response to light absorbed in the sensing region.

52. The method of claim 49, wherein the filter structure is a layered polysilicon structure with at least one layer.

53. The method of claim 49, wherein the filter structure is a layered epitaxial silicon structure with at least one layer.

54. A method of forming an array of sensing devices each of which senses light, comprising:
forming a plurality of photosensors and polysilicon filter elements at a surface of a substrate, said plurality comprising a first set and second set of photosensors, each of said first and second sets of photosensors having respective polysilicon filter elements;
the act of forming the photosensors and polysilicon filters comprising:
forming a first patterned layer of polysilicon, the first patterned layer including a respective part over each of said first set and said second set of photosensors; and
forming a second patterned layer of polysilicon, the second patterned layer including a respective part over the part of the first patterned layer over each of said second set of said photosensors;
the part of the first patterned polysilicon layer over each of the first set of photosensors being a filter that absorbs a majority of light at wavelengths shorter than a first wavelength and transmits to the photosensor a majority of light at wavelengths longer than the first wavelength;
the parts of the first and second patterned polysilicon layers over each of the second set of photosensors being a filter that absorbs a majority of light at wavelengths shorter than a second wavelength longer than the first wavelength and transmits to the photosensor a majority of light at wavelengths longer than the second wavelength.

55. A method of forming an array of sensing devices each of which senses light, comprising:
forming a plurality of photosensors and epitaxial silicon filter elements at a surface of a substrate, said plurality comprising a first set and second set of photosensors, each of said first and second sets of photosensors having respective polysilicon filter elements;
the act of forming the photosensors and epitaxial silicon filters comprising:
forming a first patterned layer of epitaxial silicon, the first patterned layer including a respective part over each of said first set and said second set of photosensors; and
forming a second patterned layer of epitaxial silicon, the second patterned layer including a respective part over the part of the first patterned layer over each of said second set of said photosensors;
the part of the first patterned epitaxial silicon layer over each of the first set of photosensors being a filter that absorbs a majority of light at wavelengths shorter than a first wavelength and transmits to the photosensor a majority of light at wavelengths longer than the first wavelength;
the parts of the first and second patterned epitaxial silicon layers over each of the second set of photosensors being a filter that absorbs a majority of light at wavelengths shorter than a second wavelength longer than the first wavelength and transmits to the photosensor a majority of light at wavelengths longer than the second wavelength.

56. A method of forming a sensing device that senses light in a wavelength range, comprising:
forming a photosensor at or beneath a surface of a substrate; and
forming a crystal silicon filter over said photosensor, the crystal silicon filter absorbing a majority of light at wavelengths shorter than a first wavelength and transmitting a majority of light at wavelengths longer than the first wavelength;
the photosensor receiving light transmitted by the crystal silicon filter, absorbing a majority of light received at wavelengths shorter than a second wavelength and longer than the first wavelength, and transmitting a majority of light received at wavelengths longer than the second wavelength.

57. A method of forming an array of sensing devices each of which senses light, comprising:
forming a plurality of photosensors and crystal silicon filter elements at a surface of a substrate, said plurality comprising a first set and second set of photosensors, each of said first and second sets of photosensors having respective crystal silicon filter elements;
the act of forming the photosensors and crystal silicon filters comprising:
forming a first patterned layer of epitaxial crystal silicon, the first patterned layer including a respective part over each of said first set and said second set of photosensors; and
forming a second patterned layer of epitaxial crystal silicon, the second patterned layer including a respective part over the part of the first patterned layer over each of said second set of said photosensors;
the part of the first patterned epitaxial crystal silicon layer over each of the first set of photosensors being a filter that absorbs a majority of light at wavelengths shorter than a first wavelength and transmits to the photosensor a majority of light at wavelengths longer than the first wavelength;
the parts of the first and second patterned epitaxial crystal silicon layers over each of the second set of photosensors being a filter that absorbs a majority of light at wavelengths shorter than a second wavelength longer than the first wavelength and transmits to the photosensor a majority of light at wavelengths longer than the second wavelength.
